(19) United States
(12) Patent Application Publication
(10) Pub. No.: US 2005/0285569 A1
(43) Pub. Date: Dec. 29, 2005

(54) Power conversion system and method

(76) Inventors: Samantha Rao, Bangalore (IN); Robert Louis Steigerwald, Burnt Hills, NY (US); Jeffrey Bernard Fortin, Niskayuna, NY (US); Somashekhar Basavaraj, Bangalore (IN)

Correspondence Address: Barry D. Blount;FLETCHER YODER, P.O. Box 692289, Houston, TX, 77269-2289, US

(21) Appl. No.: 10/878,087

(22) Filed: Jun. 28, 2004

(51) Int. Cl. H02J 7/00

(52) U.S. Cl. 320/128

(57) ABSTRACT

According to one aspect of the present technique, a power regulating system for providing a regulated voltage to a load is provided. The system comprises an energy source and a regulator circuit that receives energy from the energy source and produces a regulated voltage, which is supplied to the load. An energy storage device is charged once the regulated voltage reaches a predetermined level. In accordance with another aspect of the present technique, a method for providing a regulated voltage to a load is provided. The method includes regulating power from an energy source and controlling charging of an energy storage device. The charging is controlled by allowing the energy storage device to charge when a regulated voltage provided by a regulator circuit reaches a predetermined level.

### BACKGROUND

The invention relates generally to the field of energy harvesting and more particularly to a power conversion circuit for use with an energy harvesting device.

Energy harvesting is used to recover power that is otherwise dissipated or lost in a system. For example, energy harvesting may be used to obtain energy from solar activity, wind, thermal sources, wave action, water currents and the like. In many systems, harvested energy may be stored in a storage device for future use, as a back-up, or to supplement a deficiency in required power.

One example of an energy harvesting device is a system having a transducer that converts mechanical energy to electrical energy and stores it. Other systems convert other forms of energy into electrical energy. In some systems, stored energy recouped by an energy harvesting device may be used to power a load. After the system is started, operation of the load may be delayed until the source starts providing a predefined amount of power or until the voltage across the storage device reaches a predetermined value. In other words, supplying power to the load may be delayed because of the configuration of the energy harvesting and energy storage components of the system. The delay time can be undesirable in cases where rapid application of power to a load is an important design criterion. Previous attempts to achieve rapid output power have resulted in relatively complex solutions. However, for many applications, complex circuitry may be too expensive or difficult to implement to be practical.

Attempts to improve efficiency in power conversion circuits have included efforts to match the impedance of the load and the source to achieve higher power output. At lower power levels (for example, in the range of about 100 microwatts to 500 microwatts), minimizing power dissipation in the conversion circuit may be an alternative method to matching the impedance of the source and load for improving efficiency. Such attempts have yielded results that are too complex and expensive to implement.

Therefore, there exists a need for a technique for efficiently harvesting and storing energy in relatively low power systems while reducing power-up time required to provide power to a load. A need also exists for such a technique that is relatively easy to implement in a cost-effective manner.

### SUMMARY

According to one aspect of the present technique, a system for providing a regulated voltage to a load is provided. The system comprises an energy source and a regulator circuit that receives energy from the energy source and produces a regulated voltage, which is supplied to the load. An energy storage device is charged once the regulated voltage reaches a predetermined level. The regulator circuit is adapted to allow the energy storage device to supply power to the load when power produced by the energy source is insufficient to cause the regulated voltage to reach the predetermined level.

In accordance with another aspect of the present technique, a method for providing a regulated voltage to a load is provided. The method includes regulating power from an energy source and controlling charging of an energy storage device. The charging is controlled by allowing the energy storage device to charge when a regulated voltage provided by a regulator circuit reaches a predetermined level. The method further includes allowing the energy storage device to supply power to the load when power produced by the energy source is below the predetermined level.

### BRIEF DESCRIPTION OF THE DRAWINGS

These and other features, aspects, and advantages of the present invention may become better understood when the following detailed description is read with reference to the accompanying drawings in which like characters represent like parts throughout the drawings, wherein:

FIG. 1 is a diagrammatical view of an exemplary self-powered measurement system in accordance with aspects of the present technique;

FIG. 2 is a diagrammatical view of one exemplary embodiment of the self-powered measurement system, wherein the self-powered measurement system of FIG. 1 is implemented in a vehicular system, in accordance with aspects of the present technique;

FIG. 3 is a schematic diagram of a power regulating system in accordance with aspects of the present technique;

FIG. 4 is a schematic diagram of an alternative embodiment of a power regulating system in accordance with aspects of the present technique;

FIG. 5 is a schematic diagram of another alternative embodiment of a power regulating system in accordance with aspects of the present technique;

FIG. 6 is a schematic diagram of yet another alternative embodiment of a power regulating system in accordance with aspects of the present technique; and

FIG. 7 is a schematic diagram of yet another alternative embodiment of a power regulating system in accordance with aspects of the present technique.

### DETAILED DESCRIPTION OF EXEMPLARY EMBODIMENTS

In the subsequent paragraphs, for a better understanding of the various aspects of the present techniques, the different circuits, systems, and methods for implementation of the different aspects of the self-powered measurement system will be described in greater detail. The various aspects of the present techniques will be explained, by way of example only, with the aid of figures hereinafter.

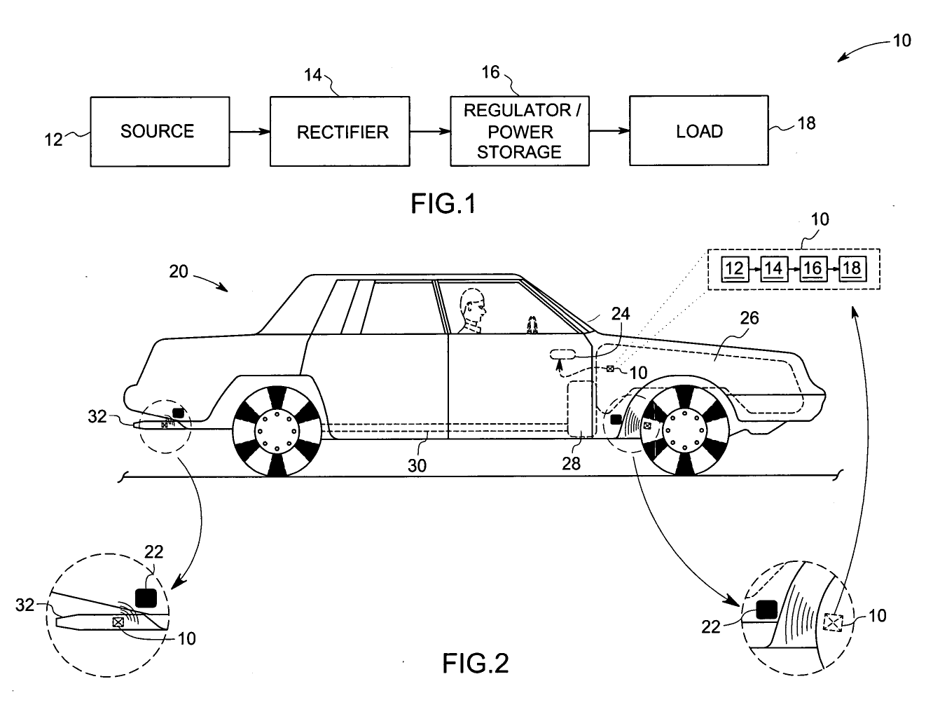

FIG. 1 is a diagrammatical view of an exemplary self-powered measurement system 10 illustrating the various functional elements of the system according to aspects of the present technique. The self-powered measurement system 10 comprises a power source 12 that provides power to a load 18. The power source 12 may be a piezoelectric transducer that converts various types of mechanical vibrations or disturbances into electrical energy.

A rectifier 14 converts varying or alternating current (ac) into a direct current (dc) signal. The specific configuration details of the rectifier 14 are matters of design choice and should not be considered limitations to the scope of the present technique. By way of example and not limitation, half-wave, full-wave, or voltage doubling rectifiers may be used as well as voltage multiplying circuits in general. Examples of voltage multiplying circuits include Cockroff and Walton voltage multiplying circuits. A regulator/power storage device 16 provides the load 18 with a constant output voltage. It may be noted that the regulator/power storage device 16 comprises a regulator circuit for providing a constant predefined output voltage. One of ordinary skill in the art would appreciate that the regulator circuit may be configured for providing a predefined voltage by utilizing components having suitable ratings for the required operation. Also, the regulator circuit may be a shunt regulator, a series regulator or the like, depending on the design criteria of the system. The regulator/power storage device 16 may comprise an energy storage device that may be utilized for storing energy either for future requirements or for providing a back-up source when power delivered by the power source 12 is insufficient to power the load 18. The energy storage device may be a capacitive storage device such as a capacitor or the like, or may be a rechargeable device such as a battery or the like. A combination of both could be used, as well.

FIG. 2 shows a diagrammatical view of one exemplary embodiment of the self-powered measurement system 10, wherein the self-powered measurement system 10 of FIG. 1 is implemented in a vehicular system 20. The vehicular system 20 comprises a vehicle (shown here as a car). Although the vehicle in the vehicular system 20 has been illustrated herein as a car, the vehicular system 20 may include an electric vehicle, a hybrid electric vehicle, a battery-operated vehicle, a gasoline-powered vehicle or the like. In one embodiment, the self-powered measurement system 10 is embedded within the tire of the vehicle. Specifically, the self-powered measurement system 10 may be located on a wheel well, or tire rim, of the vehicle. It may also be noted that the location of the self-powered measurement system 10, as depicted in FIG. 2, is only exemplary for maintaining clarity, and not for introducing any limitation. The self-powered measurement system 10 is in communicative coupling with a receiver 22 disposed on the chassis of the vehicle.

The self-powered measurement system 10 and the receiver 22 may be in a wireless communicative coupling with each other as has been illustrated. In the illustrated embodiment, piezoelectric transducer converts the energy derived from mechanical disturbances within the tire of the vehicle to electrical energy. At least a portion of the power source 12 described previously with respect to FIG. 1 may comprise the piezoelectric transducer. The self-powered measurement system comprising rectifier 14 and regulator/power storage device 16 utilizes the electrical energy from rectifier 12 to power a load 18, which in the described embodiment may be an air pressure measurement system within the tire. The gauged air pressure data may be wirelessly transmitted to the receiver 22 as illustrated in the inset. The receiver 22 may be coupled to a display panel 24 located on the dashboard of the vehicle, or any other convenient location on the vehicle. Thus, the display panel 24 may display air pressure data, temperature data or the like.

In a different embodiment, the self-powered measurement system 10 is disposed on the exhaust vent 32 of the vehicle, so that the self-powered measurement system 10 is once again wirelessly coupled to the receiver 22. Similarly in various other embodiments, the self-powered measurement system 10, comprising piezoelectric transducers, may be disposed on the chassis of the vehicle. In yet another implementation, an acoustic transducer may be employed to generate power. In still another implementation, an impact sensor designed to detect various degrees of impact or vibration applied to the vehicle may be utilized. The detected impact or vibration is converted into electrical energy and is utilized to power the load 18. Similarly, other transducers that can be used to provide electrical energy from any other form of energy may also be utilized.

In another embodiment, the self-powered measurement system 10 having a thermal transducer that is adapted to convert thermal energy into electrical energy may be disposed on the surface of the vehicle engine 26 as illustrated. By way of example, the self-powered measurement system 10 (comprising the thermal transducer) may be disposed on the vehicle engine 26. The engine 26 may be coupled by a gear box 28 to a shaft 30. The self-powered measurement system 10 may be coupled with the display panel 24 via wires, and in such a case, the display panel 24 may be configured to display temperature of the vehicle engine 26.

The power derived from the power source 12 may be rectified by the rectifier 14 and delivered to a regulator/power storage device 16 for producing a regulated output voltage. The regulated output voltage is utilized to drive a load 18, which may be one or more of a wireless sensor, a pressure sensor embedded within the wheels for measuring air pressure in the vehicle tire, a visual indicator, an audible indicator, an analog meter, a digital meter, or the like in alternative embodiments.

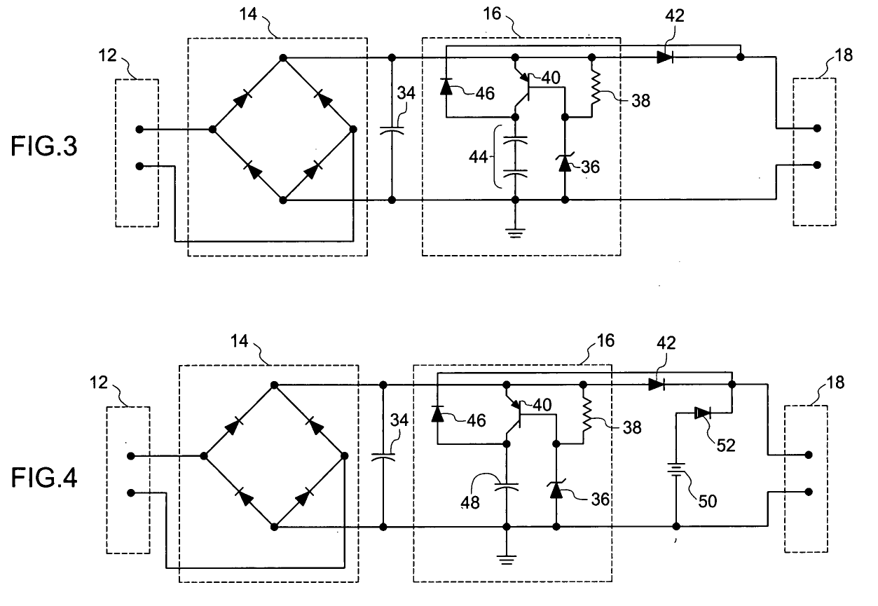

In one exemplary implementation of the self-powered measurement system 10 of FIG. 1, a circuit for regulation and storage of power is illustrated in FIG. 3. As set forth above, the power source 12 may comprise a wide range of configurations. As shown and described above with reference to FIG. 2, the mechanical vibrations that are produced within the tire of a vehicle when the vehicle is moving may be utilized to provide power. In various embodiments, light energy, energy from the motion of tides in the ocean, vibrational energy generated within the soles of a person's shoes or the like may be utilized.

The ac voltage from the power source 12 is converted into a dc voltage by the rectifier 14. A filter capacitor 34 may be used to smooth or filter variations in the output voltage of the rectifier 14. The regulator circuit within the regulator/power storage device 16 regulates the voltage delivered by the rectifier 14 so that a relatively constant voltage is provided to the load 18. The production of a relatively constant voltage may be facilitated by a Zener diode 36 and a resistor 38 in a shunt configuration, as illustrated.

A transistor 40 is initially not turned on when the system begins operation. The result is that initially, the entire power provided by the power source 12 may be utilized to operate the load 18 at its minimum operating voltage (typically less than the regulator output voltage). Thus, the load will be powered from a relatively low cut-in voltage up to and including the relatively constant voltage determined by the regulator circuit (which may be near the maximum operating voltage of the load). The Zener diode 36 along with the resistor 38 set a maximum output voltage level to be provided to the load 18. The voltage provided to the load 18 may comprise a sum of the voltage drops across the Zener diode 36 and the resistor 38 (which has a maximum voltage determined by the emitter-base voltage drop of PNP transistor 40.

Accordingly, the voltage across the load 18 may generally be represented by the following equations when the regulator is regulating:
V_{reg}=V_{Zener}+Vᵣₑₛ;
V_{load}=V_{reg}−V_{d};
i.e., V_{load}=V_{Zener}+Vᵣₑₛ−V_{d};
wherein, V_{reg} represents the regulated voltage; V_{Zener} represents the voltage drop across the Zener diode 36 (for example, V_{Zener}=about 2.5V to 2.8V); Vᵣₑₛ represents the voltage drop across the resistor 38; V_{load} represents the output voltage (for example, V_{load}=about 2.4V to 3.6V); and, V_{d} represents the voltage drop across a p-n diode 42.

Once the base-emitter voltage of the transistor 40 reaches a cut-in voltage (for example, about 0.6V-0.7V) of the transistor 40, the transistor 40 turns on and starts conducting. This occurs when the output voltage V_{load} reaches the voltage level that is normally required by the load 18. It may also be noted that, when the base-emitter voltage of the transistor 40 reaches the cut-in voltage, the Zener voltage reaches the breakdown voltage level (for example, about 2.5V-2.8V). When the transistor 40 starts conducting, a capacitive bank 44, which may comprise one or more capacitors, may start charging. The voltage across the load 18 may be maintained at a required level (V_{load}) throughout the operation, and the load 18 may be supplied with the required voltage from the power source 12 during charging of the capacitive bank 44.

Note that once the regulator begins regulating, the current in the Zener diode 36 and the emitter-base junction of the transistor 40 is limited by the internal impedance of the source device 12 (e.g., the piezoelectric generator). Alternatively, a series regulator or variable impedance could be placed in series with the source device 12. In an alternative embodiment, a rechargeable battery or a combination of a rechargeable battery and a capacitive storage device may be provided. The capacitive bank 44 stops charging after the voltage across it reaches approximately the output voltage (V_{load}). Excess energy produced after the capacitive bank 44 is fully charged may be dissipated mostly in the Zener diode 36, which produces the regulated voltage. No energy is used to charge the energy storage capacitor until the load power is being provided. Thus, the time to ramp the load power up is minimized (rather than being delayed by charging the energy storage device in parallel or at the same time as the load power is being ramped up).

When the voltage provided by the source 12 falls below a level required by the Zener diode 36 and the resistor 38 to turn on the transistor 40, the transistor 40 stops conducting. This in turn stops the charging of the capacitive bank 44. When the capacitive bank 44 is not charging and the output load voltage has fallen about a diode drop below the capacitor 44 voltage, the diode 46 starts conducting and provides the load 18 enough voltage to compensate for the deficiency in power. This helps to ensure that the load 18 receives the required voltage from the system throughout its operation. In this situation, the diodes 42 and 46 prevent the capacitive bank 44 from providing power to the Zener diode 36 and resistor 38.

In the above implementation, all the diodes that are incorporated, including the diodes in the rectifier circuitry, and the diodes 42 and 46 may be commercially available diodes. The value of the filter capacitor 34 depends on the load requirement. In one exemplary embodiment, the capacitor 34 may be a 330 microfarad tantalum capacitor. The Zener diode 36, the resistor 38, and the transistor 40 may also be commercially available components, depending on the application. The capacitive bank 44 may comprise two 10 farad ultra capacitors, depending on the amount of charge required by a given load 18. In the example set forth in FIG. 3, the regulator circuit provides an output voltage between about 2.4V to about 3.6V. The values of components chosen may vary depending on the voltage and power requirements of a particular implementation.

Referring now to FIG. 4, an alternative embodiment of a self-powered measurement system, in accordance with aspects of the present technique, is illustrated. The power source 12 and the rectifier 14 operate in a similar manner as has been explained before with respect to FIG. 1 and FIG. 3. The voltage output of the power source 12 is converted into a dc voltage by the rectifier 14 and is filtered by the filter capacitor 34. The regulator circuit in the regulator/power storage device 16 regulates the voltage to provide an output voltage in the range of, for example, about 2.4V to 3.6V.

In the embodiment shown in FIG. 4, the power storage device may comprise a capacitor 48 having a value of, for example, 4700 microfarads. The capacitor 48 may begin to charge once the emitter-base voltage of the transistor 40 reaches the turn-on voltage of the transistor 40. The diodes 42 and 46 may inhibit the capacitive storage device 48 from providing power to the Zener diode 36 and resistor 38. Throughout the charging period of the capacitor 48, the load 18 may be provided with a relatively constant voltage in the range of about 2.4V to about 3.6V by the power source 12. When the power source 12 does not provide enough power to result in a regulated voltage between about 2.4V to about 3.6V, the voltage level of the capacitor 48 creates a conductive path through diode 46 to provide the load 18 with enough power to overcome the deficiency.

An additional back-up battery 50 illustrated in the system of FIG. 4 is configured to provide the load 18 with the requisite amount of power when the power source 12 and/or the capacitive power storage device 48 are not capable of providing the load 18 with the required voltage in the range of about 2.4V to about 3.6V. Under those conditions, the diode 46 helps to ensure that the regulated voltage or the back-up battery 50 does not charge the capacitive power storage device 48. A diode 52 helps to ensure that current from the regulator circuit or the capacitive power storage device 48 does not enter the back-up battery 50.

It should be noted that the system could be configured to produce a voltage other than in the range of about 2.4V to about 3.6V. For example, the system may be configured to provide an output voltage of about 5V or any other voltage required by the load in a particular system. As set forth above, the components illustrated in FIG. 4 may be commercially available components.

In order to reduce or minimize the current needed to turn on the transistor 40 for initiating the charging of the capacitive power storage device 44 or 48, in the previously described implementations, the circuits described hereinafter with respect to FIG. 5 through FIG. 7 may be utilized. In such regard, a third implementation, which is illustrated in FIG. 5, may comprise an array of diodes 54. The array of diodes 54 may be used to provide a voltage drop equivalent to V_{Zener} (for example, about 2.5V to about 2.8V). The array of diodes 54 may be connected in a forward bias arrangement so that a total of the voltage drops across each diode in the diode array 54 constitutes an equivalent of about V_{Zener}.

The power source 12 provides a varying alternating current from the transducer, which is rectified by the rectifier 14. The rectified voltage is filtered by a filter capacitor 34. The voltage drops across the diode array 54 and a resistor 56 provides the required output voltage of between about 2.4V to about 3.6V to the load 18. When the voltage across the diode array 54 and the resistor 56 increases beyond a certain level, which is determined by the voltage drops across the diode array 54 and the resistor 56, the transistor 40 is turned on, thereby connecting the Zener diode 36 in parallel with the load 18. When the transistor 40 is turned on and the Zener diode 36 is connected parallel to the load 18, the output voltage (V_{load}) is prevented from increasing beyond the desirable voltage level of about 3 to about 3.5V. This is because the Zener diode 36 clamps any voltage above about 3 to about 3.5V. Concurrently, the diode 58 starts conducting and the capacitive storage device 48 is enabled to start charging. In the implementation shown in FIG. 5, the diode array 54 provides a relatively constant voltage output for the load 18 throughout. Again, note that the capacitive energy storage device does not begin charging until the power requirements of the load are met. This enables the load to receive power quickly.

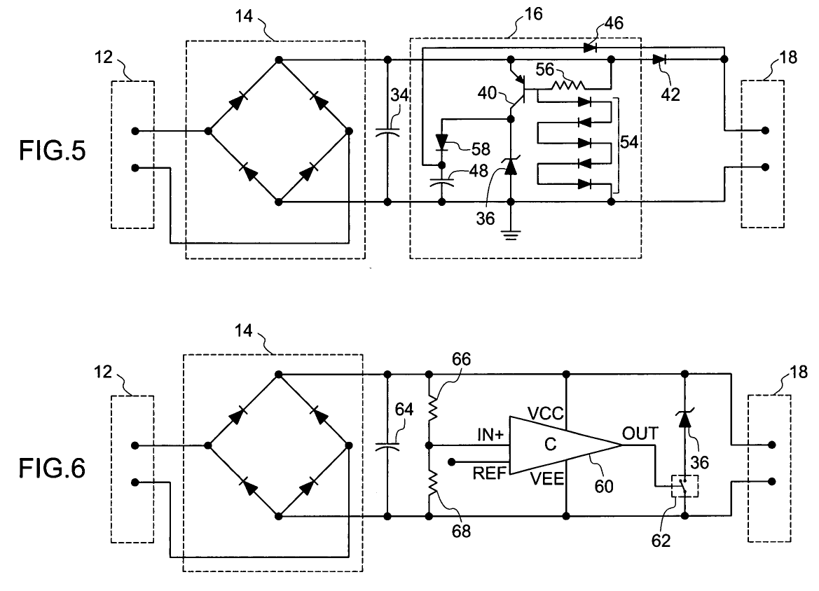

In another embodiment, which has been illustrated in FIG. 6, a comparator 60 may be utilized to ensure a relatively constant output voltage. The comparator 60 may be used to trigger a switch 62 so that the switch 62 closes when the output voltage reaches the required value. Thus, there is no leakage current associated with Zener diode as the source power is ramping up. In an exemplary embodiment, the comparator 60 may comprise an ultra-low power device.

The power source 12 provides a varying alternating current from the transducer, which is rectified by the rectifier 14. The rectified voltage is filtered by a filter capacitor 64. A voltage divider, which is formed by a resistor 66 and a resistor 68, provides an input voltage to the comparator 60. The reference voltage (V_{ref}) of the comparator 60, and the resistors 66 and 68, may be configured to provide a desirable triggering voltage for the comparator 60. The comparator 60 is powered by the voltage across the capacitor 64 by V_{cc} and Vₑₑ, as has been illustrated in FIG. 6. When the comparator 60 detects an increase in the input voltage level with respect to the reference voltage (V_{ref}), the comparator 60 triggers the switch 62 into an “ON” state. In turn, the Zener diode 36 is connected in parallel with the load 18, so that the output voltage may then be given by,
V_{load}=V_{Zener}+V_{switch},
where V_{switch} is the voltage drop across the switch 62.

Until the switch 62 is triggered into an “ON” state, the voltage continues to increase across the resistors 66 and 68. In turn, the load 18 is supplied by the voltage across the resistors 66 and 68. When the voltage across the resistors 66 and 68, reaches about 3V, the comparator 60 triggers the switch 62 so that the output voltage is restrained from increasing above about 3 to about 3.5V.

The switch 62 may be a commercially available MOSFET. It may also be a transistor, or any such switching mechanism known to one of ordinary skill in the art. All the rest of the components illustrated in FIG. 6 may also be commercially available components.

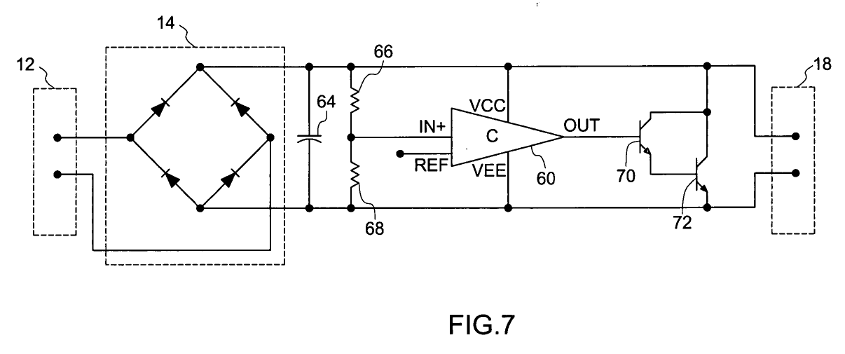

In a fifth implementation (illustrated in FIG. 7), the comparator 60 may be used to bring a Darlington transistor pair into conduction. In such an implementation, the Darlington transistor pair acts as a shunt device and feedback circuitry comprising the voltage divider resistors 66 and 68 for maintaining the output voltage level at the desired voltage. The internal impedance of the source 12 acts as the current limiting series impedance.

The power source 12 provides a varying alternating current from the transducer, which is rectified by the rectifier 14. The rectified voltage is filtered by a filter capacitor 64. A voltage divider, which is formed by the resistors 66 and 68, provides an input voltage (the output feedback voltage) to the comparator 60, which acts as an error amplifier. The comparator 60 is powered by the voltage across the filter capacitor 64 by V_{cc} and Vₑₑ. When the comparator 60 detects an increase in the input voltage level with respect to V_{ref}, the comparator 60 brings a transistor 70 into conduction. In turn, another transistor 72 that forms the Darlington pair together with the transistor 70 comes into conduction. This occurs when the voltage across the resistors 66 and 68 reaches about 3V. For such a case, the reference voltage (V_{ref}) of the comparator 60, and the resistors 66 and 68, may be configured to provide a desirable voltage for the comparator 60, as will be appreciated by one skilled in the art.

Accordingly, once the power supply 12 provides a voltage more than about 3V, the Darlington transistor pair, comprising the transistors 70 and 72, starts conducting. A current starts to flow through transistor 72, which causes a voltage drop to occur within the source series impedance. With an increase in current flowing through transistor 72, the voltage drop across the source series impedance increases, causing the voltage drop across the resistors 66 and 68 to be reduced. The reduction of voltage across the resistors 66 and 68 causes the comparator 60 to receive a lower voltage at the input (i.e. Vᵢₙ of the comparator 60), which inhibits the triggering of comparator 60. When the comparator 60 is not triggered, the transistor Darlington pair stops functioning, which increases the voltage across the resistors 66 and 68. Thus, the Darlington transistor pair varies its conduction condition to regulate the load (V_{load}) to within desirable levels.

It may be noted that any values/ratings/part numbers provided within the description above are provided by way of example only, so that they may not limit the scope of implementation of the various techniques described hereinabove. It will be appreciated by one skilled in the art that the circuits and systems described hereinabove may be configured to provide voltage levels/ranges other than that disclosed depending on system design considerations.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A power regulating system for providing a regulated voltage to a load, the system comprising:
an energy source; and
a regulator circuit that receives energy from the energy source and produces a regulated voltage to supply the load while charging an energy storage device if the regulated voltage reaches a predetermined level.

2. The system as recited in claim 1, wherein the regulator circuit is adapted to allow the energy storage device to supply power to the load when power produced by the energy source is insufficient to cause the regulated voltage to reach the predetermined level.

3. The system as recited in claim 1, wherein the predetermined level comprises a voltage requirement of the load.

4. The system as recited in claim 1, wherein the energy source comprises a transducer operable to provide electrical energy from mechanical disturbances.

5. The system as recited in claim 4, wherein the transducer comprises a piezoelectric transducer configured to acquire energy from mechanical disturbances within a vehicle tire.

6. The system as recited in claim 1, wherein the energy source comprises an acoustic energy source.

7. The system as recited in claim 1, wherein the energy source is configured to operate in the power range of about 1 microwatt to 500 microwatts.

8. The system as recited in claim 1, wherein the regulator circuit is adapted to operate as a shunt regulator.

9. The system as recited in claim 1, wherein the regulator circuit is adapted to operate as a series regulator.

10. The system as recited in claim 1, wherein the energy storage device comprises a capacitive energy storage device.

11. The system as recited in claim 1, wherein the energy storage device comprises a rechargeable battery.

12. The system as recited in claim 1, wherein the energy storage device comprises a combination of the capacitive energy storage device and the rechargeable battery.

13. The system as recited in claim 1, wherein the regulator circuit controls the flow of power to the load from either the energy source or from the energy storage device.

14. The system as recited in claim 1, wherein the load comprises a wireless sensor.

15. A vehicle having an energy harvesting device, the vehicle comprising:
a chassis comprising:
an engine;
a drive train for delivering power from the engine to one or more wheels coupled to the chassis; and
a regulator circuit that receives energy from an energy source disposed within the wheels, and produces a regulated voltage to supply a load while charging an energy storage device when the regulated voltage exceeds a predetermined level.

16. The vehicle of claim 15, wherein the regulator circuit is adapted to allow the energy storage device to supply power to the load when power produced by the energy source is insufficient to cause the regulated voltage to exceed the predetermined level.

17. The vehicle of claim 15, wherein the predetermined level comprises a voltage requirement of the load.

18. The vehicle of claim 15, wherein the vehicle comprises a hybrid electric vehicle.

19. The vehicle of claim 15, wherein the energy source comprises a piezoelectric transducer operable to convert mechanical vibrations into electrical energy.

20. The vehicle of claim 19, wherein the piezoelectric transducer is embedded within the wheels.

21. The vehicle of claim 19, wherein the piezoelectric transducer is disposed on the chassis.

22. The vehicle of claim 19, wherein the piezoelectric transducer is disposed on an exhaust pipe of the vehicle.

23. The vehicle of claim 15, wherein the energy source comprises a thermal transducer disposed on an outer surface of the engine, wherein the thermal transducer is operable to convert thermal energy to electrical energy.

24. The vehicle of claim 15, wherein the energy source comprises an acoustic transducer disposed on the chassis, wherein the acoustic transducer is operable to convert acoustic energy produced by the vehicle into electrical energy.

25. The vehicle of claim 15, wherein the energy source comprises an impact sensor disposed on the chassis of the vehicle, wherein the impact sensor is operable to produce an electrical output in response to an impact caused by braking of the vehicle.

26. The vehicle of claim 15, wherein the regulator circuit is adapted to operate as a shunt regulator.

27. The vehicle of claim 15, wherein the regulator circuit is adapted to operate as a series regulator.

28. The vehicle of claim 15, wherein the energy storage device comprises a capacitive energy storage device.

29. The vehicle of claim 15, wherein the energy storage device comprises a rechargeable battery.

30. The vehicle of claim 15, wherein the energy storage device comprises a combination of the capacitive energy storage device and the rechargeable battery.

31. The vehicle of claim 15, wherein the load comprises a pressure sensor configured to measure air pressure within a vehicle tire.

32. The vehicle of claim 15, wherein the load comprises a visual indicator.

33. The vehicle of claim 15, wherein the load comprises an audible indicator.

34. The vehicle of claim 15, wherein the load comprises at least one of a plurality of analog meters.

35. The vehicle of claim 15, wherein the load comprises at least one of a plurality of digital meters.

36. A method for providing a regulated voltage to a load, the method comprising:
regulating power from an energy source; and
controlling charging of an energy storage device by allowing the energy storage device to charge when a regulated voltage provided by a regulator circuit reaches a predetermined level.

37. The method as recited in claim 36 further comprises allowing the energy storage device to supply power to the load when power produced by the energy source is below the predetermined level.

38. The method as recited in claim 36, wherein the predetermined level comprises a voltage requirement of the load.

39. The method as recited in claim 36, wherein regulating power from an energy source comprises regulating power produced by mechanical disturbances occurring within the vehicle.

40. The method as recited in claim 36, wherein regulating power from an energy source comprises regulating power produced by an acoustic energy source.

41. The method as recited in claim 36, wherein regulating power from an energy source comprises regulating power produced by a thermal energy source.

42. The method as recited in claim 36, wherein controlling charging of an energy storage device comprises controlling charging of a capacitive energy storage device.

43. The method as recited in claim 36, wherein controlling charging of an energy storage device comprises controlling charging of a rechargeable battery.
